(19) United States
(12) Patent Application Publication
(10) Pub. No.: US 2019/0122326 A1
(43) Pub. Date: Apr. 25, 2019

(54) CARRIER

(71) Applicant: INDUSTRIAL TECHNOLOGY RESEARCH INSTITUTE, HSIN-CHU (TW)

(72) Inventors: YI-PING HUANG, Jhongli City (TW); HSUAN-YU HUANG, Chiayi (TW); PO-HUANG SHIEH, Miaoli County (TW); MING-CHENG TSAI, New Taipei (TW)

(21) Appl. No.: 15/840,340

(22) Filed: Dec. 13, 2017

(30) Foreign Application Priority Data
Oct. 24, 2017 (TW) 106136557

(51) Int. Cl. G06T 1/00; G06T 7/70; H04N 5/225; G01J 3/28; G01J 3/14; B25J 15/06; B25J 19/02

(52) U.S. Cl. CPC G06T 1/0014; G06T 7/70; H04N 5/2252; G06T 2207/30164; G01J 3/14; B25J 15/0616; B25J 19/023; G01J 3/2823

(57) ABSTRACT

A carrier includes at least one sucking member, a pressure-differentiating device, an optical unit and an image-capturing unit. The at least one sucking member, made of a flexible transparent material, has a plurality of micro holes extending in a first direction by penetrating through two opposing surfaces of the at least one sucking member. The pressure-differentiating device, connected with the at least one sucking member, is to have the at least one sucking member to perform a pressure-differentiated suction upon a workpiece. The optical unit is to capture an image of the workpiece through the at least one sucking member and to refract/reflect the image by an image-forming angle. The image-capturing unit is to capture and further output the image refracted/reflected by the optical unit in a real-time manner.

### CROSS REFERENCE TO RELATED APPLICATION

This application claims the benefits of Taiwan application Serial No. 106136557, filed Oct. 24, 2017, the disclosures of which are incorporated by references herein in its entirety.

### TECHNICAL FIELD

The present disclosure relates in general to a carrier, and more particularly to the carrier that can avoid a workpiece to break and also provide a posture of the workpiece to be detectable.

### BACKGROUND

In a conventional grab-release operation of workpiece, a capturing device such as a grip sprawl, a sucker or the like, shall be informed in advance a position and a posture of the workpiece so that the grabbing or capturing action can be performed smoothly. Thus, frequently calibrations upon the position and posture of the workpiece are generally inevitable.

For example, in a typical grab-release operation, an imaging unit is firstly applied to determine the posture of the workpiece, and then the capturing device is calibrated accordingly so as accurately to perform the grab-release operation. In general the capturing device will ship the workpiece to another work platform. As soon as the workpiece is placed on the new work platform, another aforesaid calibration upon the workpiece might be required, such that following processes upon the workpiece can be carried on. It is obvious that the aforesaid application of the capturing device consumes a lot more time.

In particular, while the conventional capturing device is applied to a fragile workpiece, even minor errors in positioning and/or posturing between the workpiece and the capturing device would be quite possible to have the capturing device to break the workpiece.

Hence, a topic of providing a carrier or capturing device that can avoid a workpiece to break due to mis-handling and therefrom prevent a manufacturing process from repeatedly calibrating is definitely urgent.

### SUMMARY

In one embodiment of this disclosure, a carrier includes at least one sucking member, a pressure-differentiating device, an optical unit and an image-capturing unit. The at least one sucking member, made of a flexible transparent material, has a plurality of micro holes extending in a first direction by penetrating through two opposing surfaces of the at least one sucking member. The pressure-differentiating device, connected with the at least one sucking member, is to have the at least one sucking member to perform a pressure-differentiated suction upon a workpiece. The optical unit is to capture an image of the workpiece through the at least one sucking member and to refract/reflect the image by an image-forming angle. The image-capturing unit is to capture and further output the image refracted/reflected by the optical unit in a real-time manner.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic view of an embodiment of the carrier in accordance with this disclosure;

FIG. 2 demonstrates schematically a theory applied in this disclosure;

FIG. 3 illustrates schematically an example of a workpiece rested on a soft pad;

FIG. 4 illustrates schematically another example of the workpiece rested on the soft pad;

FIG. 5 is a schematic view of another embodiment of the carrier in accordance with this disclosure;

FIG. 6 shows schematically a workpiece being sucked by the carrier of FIG. 5;

FIG. 7 is a schematic view of a further embodiment of the carrier in accordance with this disclosure; and

FIG. 8 shows schematically a workpiece being sucked by the carrier of FIG. 7.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

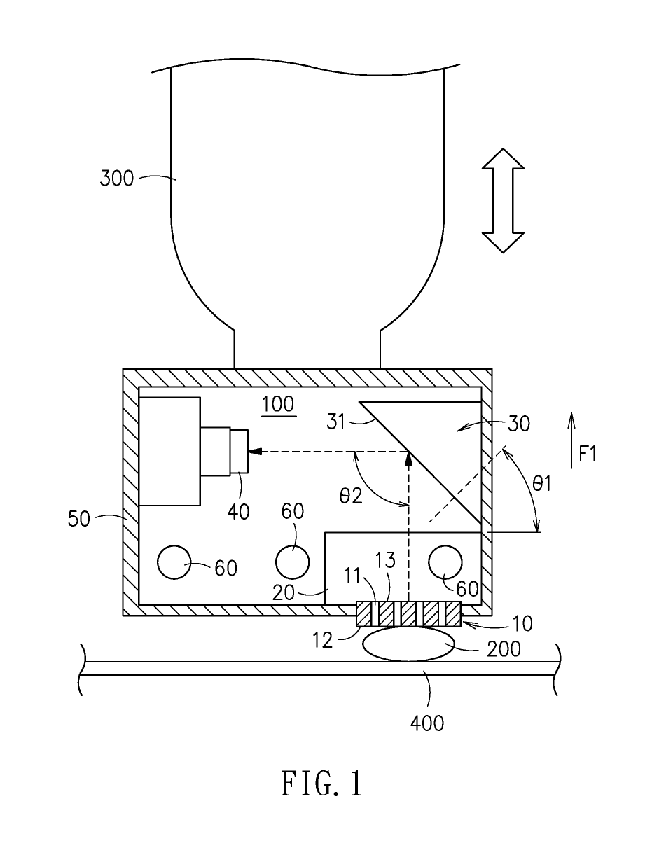

Referring to FIG. 1, the carrier 100 includes a sucking member 10, a pressure-differentiating device 20, an optical unit 30 such as an optical prism or a spectroscope, and an image-capturing unit 40. The sucking member 10, as a flexible element, can be a soft pad.

In this embodiment, the soft pad 10, as a flexible transparent element, has a plurality of micro holes 11, each of which extends through in a first direction F1 to connect two opposing sides of the soft pads 10. The soft pad 10 can be made of any relevant material such as polydimethylsiloxane (PDMS), and has no limitations on dimensions and thickness. In this disclosure, the soft pad 10 is provided according to workpiece's appearance and practical requirements. For example, the soft pad 10 can have a size of 30×30 mm and a thickness of 2˜10 mm. Further, in this disclosure, the number and hole sizes of the micro holes 11 are not strictly limited, but also per workpiece's appearance and practical requirements. Namely, softness of the soft pad 20, the design of the micro holes 12, and the thickness of the soft pad 10 are all variable and can be adjusted according to practical requirements.

The pressure-differentiating device 20, connected with the soft pad 10, can perform a pressure-differentiated suction upon a workpiece 200 through the micro holes 11. For example, the pressure-differentiating device 20 can be a vacuum device, and the soft pad 10 can generate a vacuum sucking force upon the workpiece 200 resting on a motion platform/conveying belt 400.

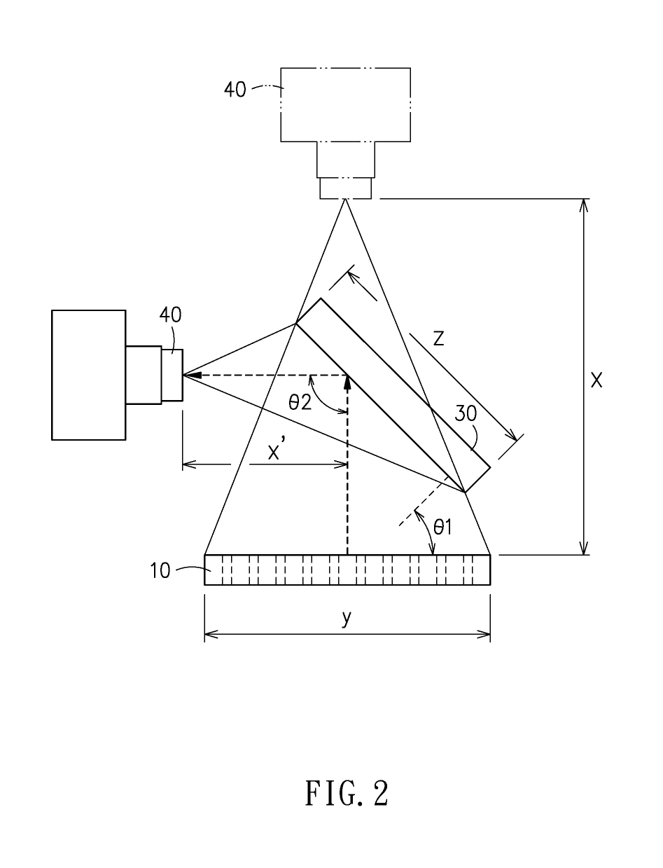

The optical prism 30 (typical for the optical unit), located at a side of the soft pad 10 that is opposing to the side thereof for the workpiece 200 to be sucked. An angle θ1 is formed by a normal line of the optical prism 30 and a surface of the soft pad 10 (the horizontal surface in FIG. 1). In this embodiment, the angle θ1 is in a 35˜55° range or no less than 45°. The optical prism 30 has a refracting/reflecting surface 31 for capturing an image of the workpiece 200 through the soft pad 10. As shown in FIG. 1, the image is refracted/reflected by the refracting/reflecting surface 31 of the optical prism 30 at an image-forming angle θ2 (90° for example). Forwarding of the image is illustrated in FIG. 1 and FIG. 2 by dashed arrowed lines.

The image-capturing unit 40 for capturing the image refracted/reflected by the optical prism 30 is further to output the image to a calculation module (not shown in the figure) coupled with the image-capturing unit 40, so that the image can be calculated and analyzed to determine the posture information (such as the position, the orientation and the like) of the workpiece 200 in a real-time manner. In one embodiment, the calculation module can be mounted inside the carrier 100, for example, integrated with the image-capturing unit 40 into a single piece. In another embodiment, the calculation module can be constructed independently to the carrier 100, and can thus receive the image from the image-capturing unit 40 in a wireless or cable manner, such that calculation and analysis for obtaining the posture information upon the received image of the workpiece 200 can be performed.

In this embodiment, the soft pad 10 is mounted to a housing 50. The soft pad 10 has two opposing surfaces; a sucking surface 12 and an image-capturing surface 13. The sucking surface 12, facing outward with respect to the housing 50, is to contact directly and thus suck the workpiece 200. The optical prism 30 and the image-capturing unit 40 area both located inside the housing 50. The refracting/reflecting surface 31 of the optical prism 30 is facing the image-capturing surface 13 so as to capture the image of the workpiece 200, and further to refract/reflect the images to the image-capturing unit 40. The light source 60 can be furnished inside the housing 50 so as for providing luminance inside the housing 50 to facilitate the capturing of the image. It shall be explained that the mounting points and the number of the light source 60 are determined according to practical needs. Thus, for example, the carrier 100 can have only one light source 60, or have many light sources 60 mounted separately.

In this embodiment, the carrier 100 can be mounted to an end portion of a robotic arm 300. Namely, the robotic arm 300 is introduced to perform as the supporting module of the carrier 100. Thereupon, the robotic arm 300 can drive the carrier 100 to displace with respect to the workpiece 200. Furthermore, the supporting module can be one of the motion platform, the conveying belt and the like.

Referring now to FIG. 2, a design equation for this present invention is as follows.

$$z = \frac{{x}^{′}}{x} \times y sec θ 1$$

in which:

z=acting length of the optical prism 30;

x′=distance between the image-capturing unit 40 and the optical prism 30 in view of a traveling path of the image (dashed arrowed lines in FIG. 2);

x=total traveling distance of the image from the soft pad 10 to the image-capturing unit 40; and

θ1=angle formed by the normal line of the optical prism 30 and the surface of the soft pad 10.

Thereupon, by disposing the image-capturing unit 40 to a position that the traveling path can form a turn of an image-forming angle θ2 at the optical prism 30, i.e. the state shown in FIG. 1, then the height and entire volume of the housing 50 can be substantially reduced.

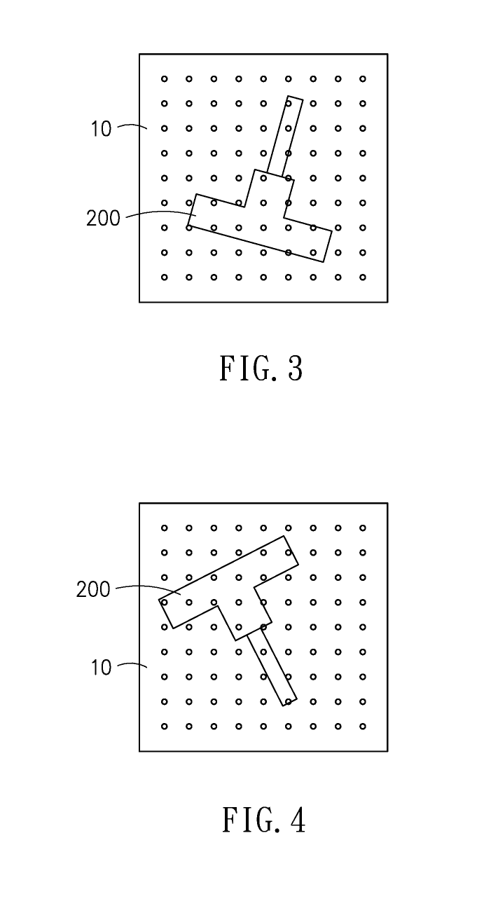

Referring now to FIG. 1, FIG. 3 and FIG. 4, in the present disclosure, the real-time image of the workpiece 200 is captured through the optical prism 30, relevant software and algorithm are integrated to perform image recognition analysis, feature extraction and algorithm analysis are applied upon the workpiece 200 so as to eliminate structural shading by the sucking member and to compensate image distortion caused by light refraction, thus the position and orientation of the workpiece 200 in a preset coordinate system can be obtained, and thereby the object of locating the workpiece 200 in a real-time manner can be achieved. Thereupon according to the present disclosure, the workpiece 200 can be arbitrarily placed, like those shown in FIG. 3 and FIG. 4.

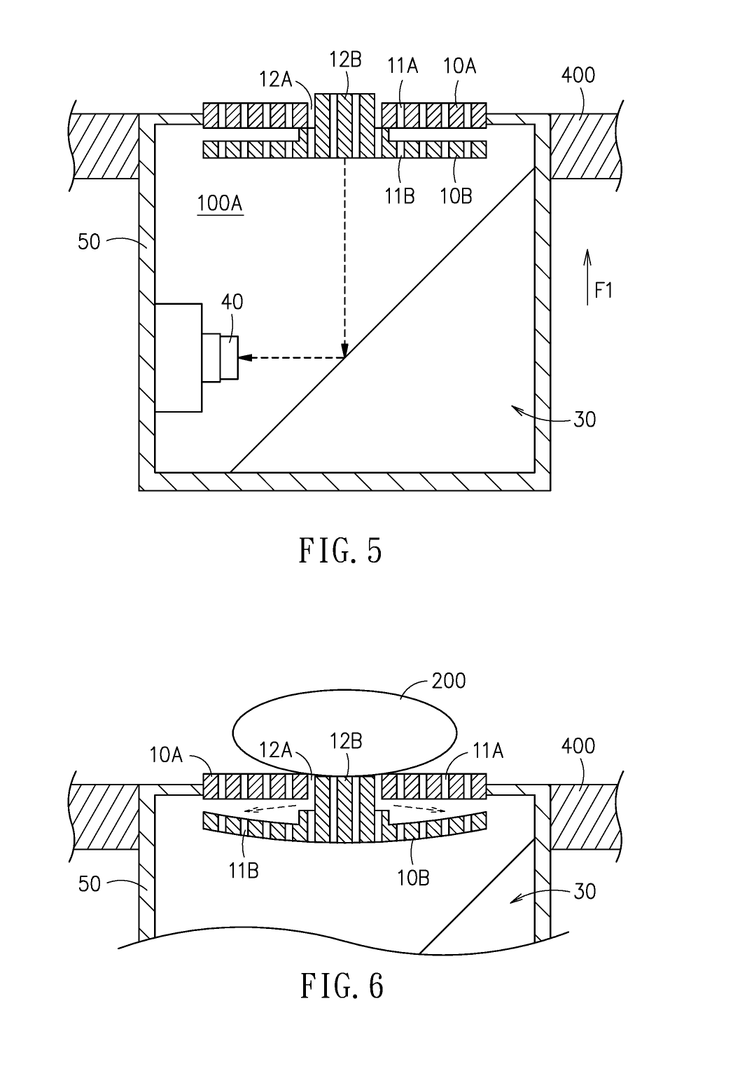

Referring now to FIG. 5 and FIG. 6, inside a housing 50 of the carrier 100A, the sucking member includes a first soft pad 10A, a second soft pad 10B, an optical prism 30 and an image-capturing unit 40.

The major difference between this embodiment and the previous embodiment shown in FIG. 1 is that, in this embodiment, the carrier 100A is furnished to a bottom of a motion platform or a conveying belt 400. Namely, the motion platform or the conveying belt 400 is introduced to serve as the supporting module for the carrier 100A.

Apparently, the mounting location of the carrier 100A is just opposing and largely symmetric to that of the carrier 100 of FIG. 1. In addition, the carrier 100A of this embodiment is furnished with a plurality of soft pads, including at least a first soft pad 10A and a second soft pad 10B. The first soft pad 10A and the second soft pad 10B are both made of a transparent material, and each of them has a plurality of micro holes 11A, 11B individually penetrating to connect two opposing sides thereof in a first direction F1. The first soft pad 10A has a through-hole portion 12A extending in the first direction F1 to connect spatially opposing sides of the first soft pad 10A. On the other hand, the second soft pad 10B has a protrusive portion 12B protruding toward the first soft pad 10A in the first direction F1 from a side of the second soft pad 10B. The second soft pad 10B is located at a side of the first soft pad 10A (the lower side of the first soft pad 10A as shown in FIG. 5), with the protrusive portion 12B to penetrate through the through-hole portion 12A and then expose a portion thereof out of the distant side of the first soft pad 10A (i.e. the upper side of the first soft pad 10A as shown in FIG. 5).

When the workpiece 200 is displaced to top the first soft pad 10A and the second soft pad 10B, the pressure-differentiating device would act between the first soft pad 10A and the second soft pad 10B (dashed arrowed lines in FIG. 6), so that the protrusive portion 12B would be pushed to shift downward. At this moment, the workpiece 200 is sucked and sustained by both the top surface of the protrusive portion 12B and the first soft pad 10A. Then, the real-time image of the workpiece 200 would be captured by the image-capturing unit 40 through the optical prism 30, so as to base on the image to carry out the real-time algorithm analysis for deriving the posture information of the workpiece 200, such as the position and the orientation.

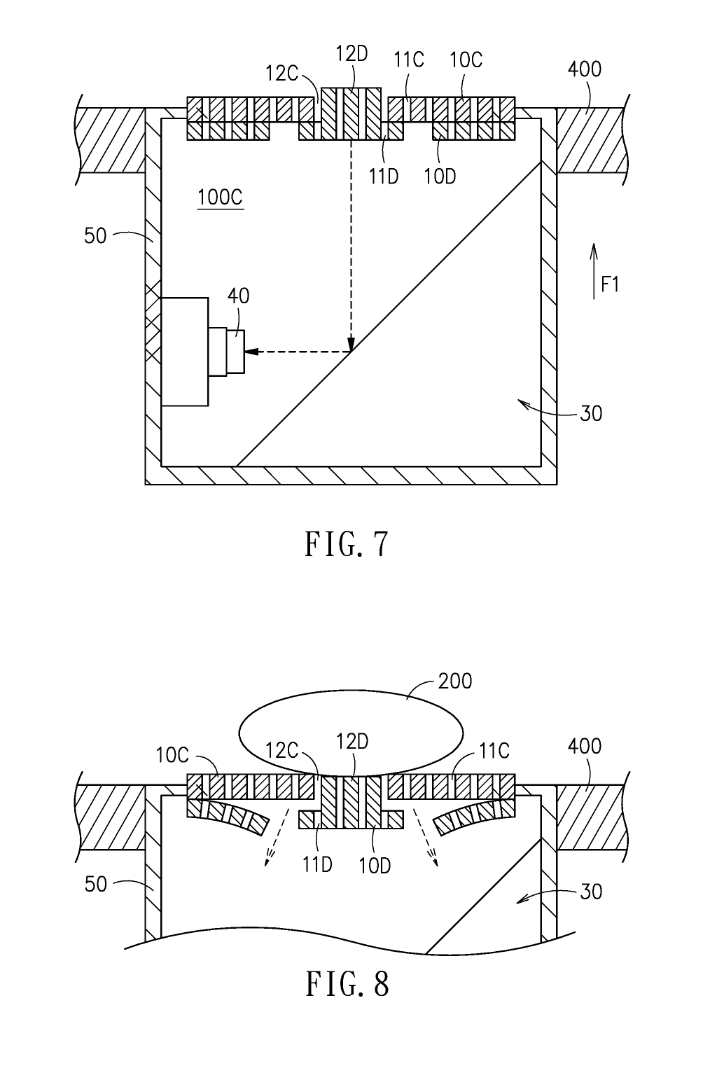

Referring now to FIG. 7 and FIG. 8, inside a housing 50 of the carrier 100C, the sucking member includes a first soft pad 10C, a second soft pad 10D, a pressure-differentiating device (not shown in the figure), an optical prism 30 and an image-capturing unit 40.

In this embodiment, the first soft pad 10C and the second soft pad 10D are structured slightly different to the first soft pad 10A and the second soft pad 10B of FIG. 5, but functioned mainly the same in between.

When the workpiece 200 is displaced to top the first soft pad 10C and the second soft pad 10D, the pressure-differentiating device would act between the first soft pad 10C and the second soft pad 10D (dashed arrowed lines in FIG. 8), so that the protrusive portion 12D would be pushed downward. At this moment, the workpiece 200 is sucked and sustained by both the top surface of the protrusive portion 12D and the first soft pad 10C. Then, the real-time image of the workpiece 200 would be captured by the image-capturing unit 40 through the optical prism 30, so as to base on the image to carry out the real-time algorithm analysis for deriving the posture information of the workpiece 200, such as the position and the orientation.

It shall be explained that, if the embodiment of FIG. 1 is turned upside down and furnished to the bottom of the motion platform or the conveying belt 400, the embodiment shown in FIG. 5 or FIG. 7 can be obtained. From the embodiments of FIG. 1, FIG. 5 and FIG. 7, it is proved that the carrier of the present disclosure can be mounted to a movable robotic arm 300, a motion platform or a conveying belt 400. However, among all these variations in the carrier, the work functions are the same to suck the workpiece and further to judge its posture, such that the following manufacturing processes upon the workpiece can be carried out much easily.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A carrier, comprising:
at least one sucking member, made of a flexible transparent material, having a plurality of micro holes extending in a first direction by penetrating through two opposing surfaces of the at least one sucking member;
a pressure-differentiating device, connected with the sucking member, being to have the sucking member to perform a pressure-differentiated suction upon a workpiece;
an optical unit, being to capture an image of the workpiece through the sucking member and to refract/reflect the image by an image-forming angle; and
an image-capturing unit, being to capture and further output the image refracted/reflected by the optical unit.

2. The carrier of claim 1, wherein the pressure-differentiating device is a vacuum device for having the sucking member to generate a vacuum sucking force upon the workpiece.

3. The carrier of claim 1, wherein the optical unit is located at one side of the sucking member opposing to another side for sucking the workpiece.

4. The carrier of claim 1, wherein the image-forming angle is 90°.

5. The carrier of claim 1, wherein a normal line of the optical unit forms an angle with a surface of the sucking member, and the angle is between 35˜55°.

6. The carrier of claim 1, wherein the sucking member is furnished to a housing, the two opposing surfaces are a sucking surface and an image-capturing surface, the sucking surface faces out of the housing, the optical unit and the image-capturing unit are located inside the housing, and a refracting/reflecting surface of the optical unit faces the image-capturing surface so as to capture the image and further refract/reflect the image to the image-capturing unit.

7. The carrier of claim 6, wherein the housing includes thereinside a light source for providing luminance inside the housing.

8. The carrier of claim 1, wherein the sucking member includes a plurality of the sucking members, each said sucking member having a plurality of micro holes and further including:
a first soft pad, having a through-hole portion extending in the first direction to penetrate two opposing sides of the first soft pad; and
a second soft pad, having a protrusive portion protruding in the first direction from a surface of the second soft pad, located at one side of the first soft pad, the protrusive portion penetrating through the through-hole portion and exposing a portion thereof over the first soft pad for sucking and sustaining the workpiece with the first soft pad.

9. The carrier of claim 1, wherein the sucking member is a soft pad.

10. The carrier of claim 8, wherein the sucking member is a soft pad.

11. The carrier of claim 1, wherein the optical unit is one of an optical prism and a spectroscope.

12. The carrier of claim 1, wherein the carrier is disposed at a supporting module, and the supporting module is one of a robotic arm, a motion platform and a conveying belt.

13. The carrier of claim 9, wherein the soft pad is made of a polydimethylsiloxane (PDMS).

14. The carrier of claim 10, wherein the soft pad is made of a polydimethylsiloxane (PDMS).

15. The carrier of claim 1, wherein the image-capturing unit is coupled with a calculation module, the calculation module being to receive the image outputted by the image-capturing unit and to perform real-time algorithm analysis upon the workpiece so as to obtain corresponding posture information.
